(19) United States
(12) Patent Application Publication
(10) Pub. No.: US 2009/0031877 A1
(43) Pub. Date: Feb. 5, 2009

(54) SAW BLADE ASSEMBLY FOR A CUTTING SAW

(75) Inventors: Sylvain Gilbert, St-Prime (CA); Daniel Pare, St-Prime (CA); Dominic Perron, St-Prime (CA)

Correspondence Address: MERCHANT & GOULD PC, P.O. BOX 2903, MINNEAPOLIS, MN, 55402-0903, US

(73) Assignee: LES PRODUITS GILBERT INC., Roberval (CA)

(21) Appl. No.: 11/833,574

(22) Filed: Aug. 3, 2007

(51) Int. Cl. B23D 61/04

(52) U.S. Cl. 83/840; 83/835; 83/839

(57) ABSTRACT

A saw blade assembly for a cutting saw is provided, which includes an effectively circular polygonal disc with an outer edge defined by multiple flat sides, and numerous saw tooth holders, each saw tooth holder removably mounted on a corresponding flat side along the outer edge of the polygonal disc. Preferably, each saw tooth holder straddles the corresponding flat side of the polygonal disc. The saw tooth holder may have a body with a flat abutment surface abutting the corresponding flat side of the polygonal disc, a first leg extending from the body along a first surface of the polygonal disc, and a second leg extending from the body along a second surface of the polygonal disc. For each saw tooth holder, the saw blade assembly may also include fastening means removably mounting the saw tooth holder to the polygonal disc.

### FIELD OF THE INVENTION

The present invention relates to cutting saws. More specifically, the invention relates to a saw blade with removable saw tooth holders.

### BACKGROUND OF THE INVENTION

Cutting saws are used to cut wood or other material. Some saws use an abrasive disc or band for cutting while other saws use a serrated blade with a dentated, or toothed, outer edge.

In the lumber industry, circular saws are used on tree-felling heads. Many prior art circular saws for this industry include a circular disc with tooth holders mounted about the periphery of the disc and supporting cutting teeth. Should a tooth be damaged in the process of cutting, the tooth is simply removed from the holder and replaced. In addition, teeth of different shape and size are required for different cutting jobs. As such, saw blades with removable saw tooth holders provide good versatility. As the saw blade is subjected to stress and shock, it is important that the saw tooth holder remain securely in place not only to avoid damaging the wood fiber and to provide a precise clean cut but also to ensure the safety of the operators.

Numerous saw blade assemblies are specified and known in the art.

U.S. Pat. No. 5,377,731 (Wildey) describes a saw blade of a type that is used in a tree felling head. The saw blade has a disc provided with tooth holders about its periphery that support cutting teeth asymmetrically above an inner plate of the disc. As shown in FIG. 1 of Wildey, the tooth holders are in the form of protrusions radially projecting from the rim of the disc. Each tooth holder has a transverse central mounting bore. The mounting bore has a larger diameter on one side to receive the shank of a tooth, and a smaller diameter on the other side to receive the shank of a bolt screwed in the shank of the tooth to hold it in place on the tooth holder. One problem with this tooth retaining system is that the tooth holders must be sufficiently spaced from one another to leave enough space for passage of the bit used to drill the mounting bores, thereby limiting the number of possible teeth and tooth holders around the saw blade (e.g. to 18 teeth) and forcing them to be undesirably remote from one another, which reduce the cutting efficiency of the saw blade. Also, the impact on the outer edge of the teeth produces a shearing force on the tooth retaining system, i.e. the shanks of the teeth and the bolts, causing premature wear due to the configuration of the teeth and of the tooth holders. The tooth holders may be separate from the disc and are fastened to it using bolts extending across superimposed portions of the tooth holders and the disc. Such a mounting arrangement presents certain risks for the blade such as holders becoming loose.

U.S. Pat. No. 5,085,112 (MacLennan) describes a saw tooth and holder and means for mounting the holder to a saw. As shown in FIG. 2 of MacLennan, the saw tooth holders straddle the arced rim of a circular disc. This requires that the surface of the tooth holder in contact with the arced rim be arced accordingly. Any slight differences in the arc of the rim and the arc of the tooth holder may result in misaligned teeth or loose tooth holders hence adversely affecting the cutting process. In addition, the machining of the arced surfaces of the tooth holders adds to the cost of the holders. Moreover, the arced surfaces of these tooth holders render the holders saw-blade specific—the tooth holders are not easily interchangeable.

As such, there is a need for a saw blade assembly that alleviates at least some of the above-mentioned drawbacks of the prior art.

### SUMMARY OF THE INVENTION

In accordance with one aspect of the present invention, there is provided a saw blade assembly for a cutting saw. The saw blade assembly includes a polygonal disc having an outer edge including multiple flat sides, the outer edge defining an effectively circular shape, and a plurality of saw tooth holders, each being removably mounted on a corresponding flat side of the polygonal disc. Each saw tooth holder has a flat abutment surface abutting the corresponding flat side.

According to one embodiment, the saw blade assembly further includes fastening means, for each saw tooth holder, removably mounting the saw tooth holder to the polygonal disc. The fastening means may include a bolt extending through the saw tooth holder and polygonal disc, and an internally-threaded bushing cooperating with the bolt. Alternatively, the fastening means may include a rivet extending through the saw tooth holder and polygonal disc.

In accordance with another aspect of the present invention, there is provided a saw blade assembly for a cutting saw which includes a polygonal disc having an outer edge including multiple flat sides, the outer edge defining an effectively circular shape, and a plurality of saw tooth holders, each saw tooth holder removably mounted on a corresponding flat side along the outer edge of the polygonal disc and straddling the corresponding flat side of the polygonal disc. The saw tooth holder has a body including a flat abutment surface abutting the corresponding flat side of the polygonal disc, a first leg extending from the body along a first surface of the polygonal disc, and a second leg extending from the body along a second surface of the polygonal disc. For each saw tooth holder, the saw blade assembly also includes fastening means removably mounting the saw tooth holder to the polygonal disc.

Preferably, for receiving the fastening means, the polygonal disc has at least one opening therethrough proximate the corresponding flat side, the first leg has at least one opening therethrough, and the second leg has at least one opening therethrough in central axial alignment with the at least one opening through the first leg and the at least one opening through the polygonal disc.

According to one embodiment, the fastening means may include at least one collared plain bushing inserted into the first leg, an internally-threaded bushing inserted into the second leg, and a countersink-head bolt extending through the collared plain bushing and threaded into the internally-threaded bushing. According to another embodiment, the fastening means may include at least one rivet extending through the first leg of the saw tooth holder, the polygonal disc, and the second leg of the saw tooth holder.

In accordance with another aspect of the present invention, there is provided a polygonal disc for a cutting saw adapted for receiving a plurality of removable saw tooth holders mounted thereon, each saw tooth holder having a flat abutment surface. The polygonal disc includes an outer edge including multiple sides, wherein the outer edge defines an effectively circular shape and each of the multiple sides is flat for abutting the flat abutment surface of the saw tooth holder mounted thereon. Preferably, each of the multiple sides accommodates at least one saw tooth holder.

In accordance with yet another aspect of the present invention, there is provided a saw tooth holder for a cutting saw that has a polygonal disc including an outer edge having multiple flat sides, the outer edge defining an effectively circular shape. The saw tooth holder includes a flat abutment surface for abutting a corresponding flat side of the polygonal disc. Preferably, the saw tooth holder is adapted for straddling the flat side, the saw tooth holder having a body defined by the flat abutment surface, a first leg extending from the body, and a second leg extending from the body.

Advantages of the present invention include a saw blade assembly where the removable saw tooth holders are easily and immovably mounted onto a multi-sided polygonal disc.

The objects, advantages and other features of the present invention will become more apparent and be better understood upon reading of the following non-restrictive description of the preferred embodiments of the invention, given with reference to the accompanying drawings. The accompanying drawings are given purely for illustrative purposes and should not in any way be interpreted as limiting the scope of the invention.

### BRIEF DESCRIPTION OF THE DRAWINGS

FIG. 1 is a front view of a saw blade assembly, according to an embodiment of the invention, showing a plurality of saw tooth holders mounted on a polygonal disc.

FIG. 1A is a detail view of portion A of FIG. 1, showing a mounted saw tooth holder.

FIG. 1B is a cross-section view taken along line B-B of FIG. 1A, showing a bolt mounting according to one embodiment of the invention.

FIG. 1C is a cross-section view taken along line C-C of FIG. 1A, showing a rivet mounting according to one embodiment of the invention.

FIG. 1D is a top view of detail A of FIG. 1A with the flat abutment surface of the saw tooth holder abutting the flat side of the polygonal disc shown in phantom line.

FIG. 2 is an exploded view of a saw tooth holder mounted on a polygonal disc, in accordance with one embodiment of the invention.

FIG. 3 is an exploded view of a saw tooth holder mounted on a polygonal disc, in accordance with one embodiment of the invention.

### DESCRIPTION OF PREFERRED EMBODIMENTS OF THE INVENTION

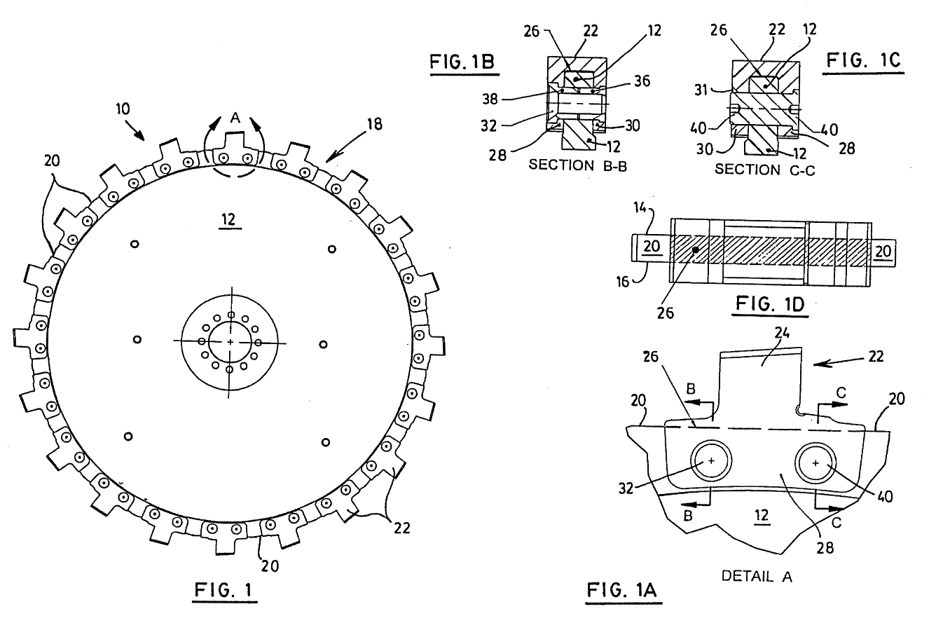

The present invention will be described more fully hereinafter with reference to the accompanying drawings, FIGS. 1, 1A, 1B, 1C, 1D, 2, and 3, in which like numerals refer to like elements throughout.

According to one aspect of the invention, there is provided a saw blade assembly for a cutting saw. The saw blade assembly is preferably intended for use in a tree-felling circular saw. Of course, the saw blade assembly is not limited to being used in wood-cutting saws—it may be used in any appropriate cutting saw, for example a metal-cutting saw.

Referring more specifically to FIG. 1, there is shown a saw blade assembly 10 according to one embodiment of the invention. The saw blade assembly 10 includes a polygonal disc 12 and a plurality of saw tooth holders 22 mounted thereon.

The polygonal disc 12 has an outer edge 18 which includes multiple flat sides 20. Albeit multi-sided, the polygonal disc 12 is effectively circular in shape.

Each saw tooth holder 22 is removably mounted on one of the multiple flat sides 20 of the polygonal disc 12. A saw tooth holder 22 may be mounted on each and every flat side 20 of the polygonal disc, or on every other flat side 20 or any other appropriate pattern, depending on the geometry of the assembly and on the quality of the cut required (the number of saw teeth determine the quality of the cut). Advantageously, should the saw tooth holder 22 be damaged during use of the cutting saw, the saw tooth holder may be removed and replaced with a new holder. To allow for a clean and precise cut and avoid damaging the wood, a stable and secure mounting of the saw tooth holder 22 is needed. As such, each saw tooth holder 22 has a flat abutment surface 26 which abuts the flat side 20 of the polygonal disc, best shown in FIGS. 1A, 1B, 1C, and 1D.

According to the embodiments shown in the drawings, each saw tooth holder 22 straddles a flat side 20 of the polygonal disc 12 and has a body 24 which is includes on one of its sides the flat abutment surface 26 abutting the flat side 20, a first leg 28 extending from the body 24 along a first surface 14 of the polygonal disc 12, and a second leg 30 extending from the body 24 along a second surface 16 of the polygonal disc 12. Advantageously, the first and second legs 28 and 30 advantageously act as braces providing steady seating of the tooth holder 22.

Of course, it is understood that the saw tooth holders 22 may be of any form as long as they have a flat abutment surface 26 for abutting securely against the flat side 20 of the polygonal disc 12 onto which they are mounted. As any person in the art would understand, the saw tooth holders may be further configured to accommodate a number of specific saw teeth.

The saw blade assembly 10 may further include fastening means removably mounting the saw tooth holders 22 to the polygonal disc 12. Preferably, for ease of assembly, the polygonal disc 12 has at least one opening 21 therethrough proximate each flat side, and the first 28 and second 30 legs of each saw tooth holder 22 have at least one corresponding opening 29 and 31 therethrough in axial alignment with any one of the openings 21 through the polygonal disc.

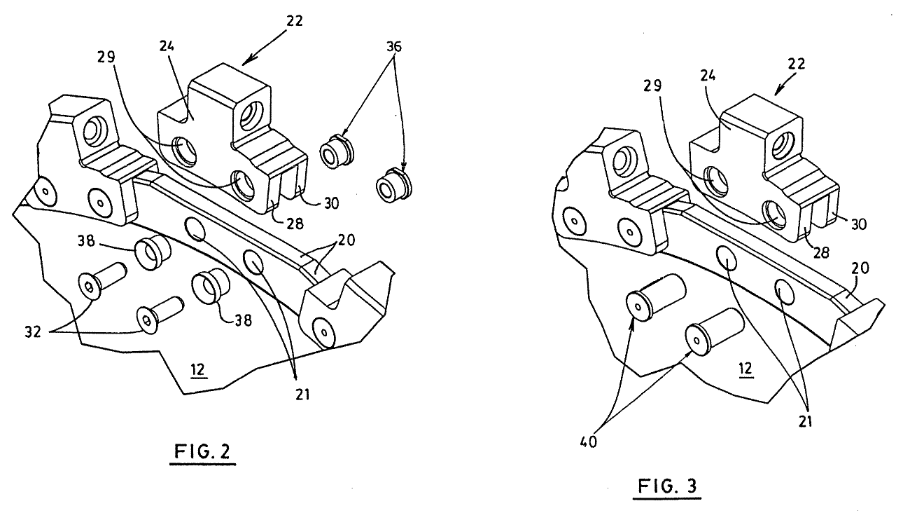

According to one embodiment, the fastening means may include a bolt 32 and bushing extending through the saw tooth holder 22 and the polygonal disc 12. As shown in FIG. 1B and FIG. 2, the fastening means may include a collared plain bushing 38 inserted into an opening 29 of the first leg 28 of a saw tooth holder 22, and an internally-threaded bushing 36 inserted into the corresponding opening in the second leg 30 of the saw tooth holder 22, and a countersink-head bolt 32 extending through the collared plain bushing 38 and threaded into the internally-threaded bushing 36 thereby fastening the saw tooth holder 22 to the polygonal disc 12. Optionally, the collared plain bushing and internally-threaded bushing may be replaced by a single internally-threaded bushing inserted into the second leg and extending all the way through the first leg. The use of bushings allows to minimize any damage to the polygonal disc 12 and saw tooth holder 22 due to friction.

According to another embodiment, the fastening means may include a rivet 40 extending through the saw tooth holder 22 and the polygonal disc 12. As shown in FIG. 1C and FIG. 3, the fastening means may include a rivet 40 extending through an opening 29 of the first leg 28 of a saw tooth holder 22, an opening 21 in the polygonal disc 12, and an opening 31 in the second leg 30 of the saw tooth holder 22.

According to other embodiments of the invention, the fastening means may include a bolt (threaded or not) and some other appropriate mating lock means, for example a locking nut.

Although it is possible to use either one bolt 32 and cooperating internally threaded bushing 36 or one rivet 40 to mount each saw tooth holder to the polygonal disc, to increase stability and to avoid loosening of the saw tooth holder 22, it is preferably that at least two bolts and two cooperating internally-threaded bushings or two rivets be used.

In accordance with another aspect of the preset invention, there is provided a polygonal disc for a cutting saw having a number of removable saw tooth holders that have a flat abutment surface. The polygonal disc as mentioned above is effectively circular in shape and has an outer edge with multiple sides. Each of the multiple sides is flat for abutting the flat abutment surface of the saw tooth holder mounted thereon. Preferably, each of the flat sides accommodates a single saw tooth holder.

In accordance with yet another aspect of the present invention, there is provided a saw tooth holder for a cutting saw that includes an effectively circular polygonal disc with an outer edge having multiple flat sides. The saw tooth holder as mentioned above includes a flat abutment surface for abutting a flat side of the polygonal disc. Preferably, the saw tooth holder is of a form which allows it to straddle the flat side: the saw tooth holder has a body defined by the flat abutment surface, a first leg extending from the body, and a second leg extending from the body.

The saw blade assembly of this invention provides reliability of a one-piece saw disc with the versatility of replaceable removably-mounted saw tooth holders, but stability and precision with its mounted saw tooth holders in flat abutment contact with the flat sides of the multi-flat-sided polygonal disc.

Numerous modifications could be made to any of the embodiments described above without departing from the scope of the present invention as defined in the appended claims.

1. A saw blade assembly for a cutting saw, said saw blade assembly comprising:
a polygonal disc having an outer edge comprising multiple flat sides, said outer edge defining an effectively circular shape; and
a plurality of saw tooth holders, each saw tooth holder being removably mounted on a corresponding flat side of the polygonal disc, each saw tooth holder having a flat abutment surface abutting said corresponding flat side.

2. The saw blade assembly for a cutting saw according to claim 1, wherein said saw blade assembly further comprises, for each saw tooth holder, fastening means removably mounting said saw tooth holder to the polygonal disc.

3. The saw blade assembly for a cutting saw according to claim 2, wherein each of said fastening means comprise a bolt extending through the corresponding saw tooth holder and the polygonal disc and an internally-threaded bushing cooperating with the bolt.

4. The saw blade assembly for a cutting saw according to claim 2, wherein each of said fastening means comprise a rivet extending through the corresponding saw tooth holder and the polygonal disc.

5. The saw blade assembly for a cutting saw according to claim 1, wherein each of said saw tooth holders straddles the corresponding flat side of the polygonal disc, said saw tooth holder having a body comprising the flat abutment surface abutting said corresponding flat side of the polygonal disc, a first leg extending from the body along a first surface of the polygonal disc, and a second leg extending from the body along a second surface of the polygonal disc.

6. A saw blade assembly for a cutting saw, said saw blade assembly comprising:
a polygonal disc having an outer edge comprising multiple flat sides, said outer edge defining an effectively circular shape;
a plurality of saw tooth holders, each saw tooth holder removably mounted on a corresponding flat side along the outer edge of the polygonal disc, wherein each saw tooth holder straddles the corresponding flat side of the polygonal disc, said saw tooth holder having a body comprising a flat abutment surface abutting said corresponding flat side of the polygonal disc, a first leg extending from the body along a first surface of the polygonal disc, and a second leg extending from the body along a second surface of the polygonal disc; and
for each saw tooth holder, fastening means removably mounting the saw tooth holder to the polygonal disc.

7. The saw blade assembly according to claim 6, wherein, for receiving the fastening means associated with each saw tooth holder:
the polygonal disc has at least one opening therethrough proximate the corresponding flat side;
the first leg has at least one opening therethrough; and
the second leg has at least one opening therethrough in central axial alignment with the at least one opening through the first leg and the at least one opening through the polygonal disc.

8. The saw blade assembly according to claim 7, wherein the fastening means associated with each saw tooth holder comprise at least one rivet extending through the first leg of the saw tooth holder, the polygonal disc, and the second leg of the saw tooth holder.

9. The saw blade assembly according to claim 7, wherein the fastening means associated with each saw tooth holder comprise at least one collared plain bushing inserted into the first leg, an internally-threaded bushing inserted into the second leg, and a countersink-head bolt extending through the collared plain bushing and threaded into the internally-threaded bushing.

10. The saw blade assembly according to claim 7, wherein the fastening means associated with each saw tooth holder comprise:
at least one bolt extending through the first leg, the polygonal disc, and the second leg; and
at least one internally-threaded bushing cooperating with said at least one bolt.

11. A polygonal disc for a cutting saw adapted for receiving a plurality of removable saw tooth holders mounted thereon, each saw tooth holder having a flat abutment surface, said polygonal disc comprising:
an outer edge comprising multiple sides, said outer edge defining an effectively circular shape; and
wherein each of the multiple sides is flat for abutting the flat abutment surface of the saw tooth holder mounted thereon.

12. The polygonal disc for a cutting saw according to claim 11, wherein each of the multiple sides accommodates at least one saw tooth holder.

13. A saw tooth holder for a cutting saw that has a polygonal disc comprising an outer edge having multiple flat sides, said outer edge defining an effectively circular shape, said saw tooth holder comprising:
a flat abutment surface for abutting a corresponding flat side of the polygonal disc.

14. The saw tooth holder according to claim 13, wherein said saw tooth holder is adapted for straddling said corresponding flat side, said saw tooth holder having a body defined by the flat abutment surface, a first leg extending from the body, and a second leg extending from the body.
